(19) United States
(12) Patent Application Publication
(10) Pub. No.: US 2005/0055835 A1
(43) Pub. Date: Mar. 17, 2005

(54) Slip-resistant hand tool handle

(75) Inventors: Melvin Pardue, Repton, AL (US); Steven Ingram, Portland, OR (US)

Correspondence Address: IPSOLON LLP, 805 SW BROADWAY, #2740, PORTLAND, OR, 97205, US

(73) Assignee: Mentor Group LLC

(21) Appl. No.: 10/663,460

(22) Filed: Sep. 15, 2003

(51) Int. Cl. B26B 1/10

(52) U.S. Cl. 30/340

(57) ABSTRACT

A hand tool such as a folding knife, fixed blade knife, multitool and the like has a handle with a slip-resistant grasp. The handle incorporates a bi-directional saw-tooth pattern formed into the handle surface that defines a ridged pattern that is generally transverse to the longitudinal axis of the handle. A first plurality of ridges face in the rearward direction and a second plurality of ridges face in the forward direction. The bi-directional pattern provides a secure grip in all orientations.

### FIELD OF THE INVENTION

This invention relates to slip-resistant handles for hand tools such as knives and multitools, and more specifically to a handle having a gripping surface textured with a bi-directional tread pattern to increase gripping strength.

### BACKGROUND

Knives and other similar hand tools such as multitools have a handle portion and a blade or implement that extends from the handle. Regardless of whether the blade folds into the handle for storage or is fixed in a working position, during use the user grasps the handle in his or her hand. The handle is usually designed to be comfortable and to provide a secure gripping platform for holding the tool while it is being used.

It will be appreciated by anyone who has used a hand tool that it is important for many reasons that the user is able to securely grasp the handle in all conditions. Among other reasons for needing a secure grip on the handle, it is easier to use the tool for its intended purpose. Perhaps more importantly, a secure grasp on the handle increases user safety. As one example, knives are used in all types of conditions. In some conditions, the knife handle may become very slippery, for instance when the handle is wet or muddy, when the user's hands become sweaty, or in the case of knives used for hunting, when the knife is used to clean an animal. The need for a secure grasp on the handle is important at all times, but is of utmost importance in adverse situations to make the knife both safe and useable.

There are many types of handle designs that are intended to provide a secure gripping surface, and given the need to improve safety, comfort and usability, there is an ongoing need for improved handle designs.

The present invention relates to a hand tool handle that has an improved surface that provides the user with a secure grasp. The handle has a bi-directional, oppositely facing saw-tooth pattern formed into the handle surface that defines a series of ridges that may be arcuate but extend generally transverse to the longitudinal axis of the handle. The bi-directional pattern provides a secure grip in all orientations, even when pushing the handle forward or pulling it backward along the longitudinal axis of the handle.

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a perspective view of a hand tool—in this case a folding, locking knife with the blade extended into the working position—having a handle formed in accordance with the illustrated invention.

FIG. 2 is a side elevation view of the handle of the knife shown in FIG. 1.

FIG. 3 is a side elevation view of a knife handle similar to the knife handle shown in FIG. 2, but illustrating the saw-tooth ridge pattern extending completely across the handle.

FIG. 4 is a cross sectional view of the handle shown in FIG. 3, taken along the line 4-4 of FIG. 3.

FIG. 5 is a view of a hand tool similar to the tool show in FIG. 1, but in this case a folding knife without a lock—having a handle formed in accordance with the illustrated invention.

FIG. 6 is a side elevation view of the handle of the knife shown in FIG. 5.

FIG. 7 is a side elevation view of a knife handle similar to the knife handle shown in FIG. 6, but illustrating the textured ridge pattern extending completely across the handle.

FIG. 8 is a close up sectional view of a central portion of a knife handle as shown in FIG. 1

### DETAILED DESCRIPTION OF THE PREFERRED EMBODIMENTS

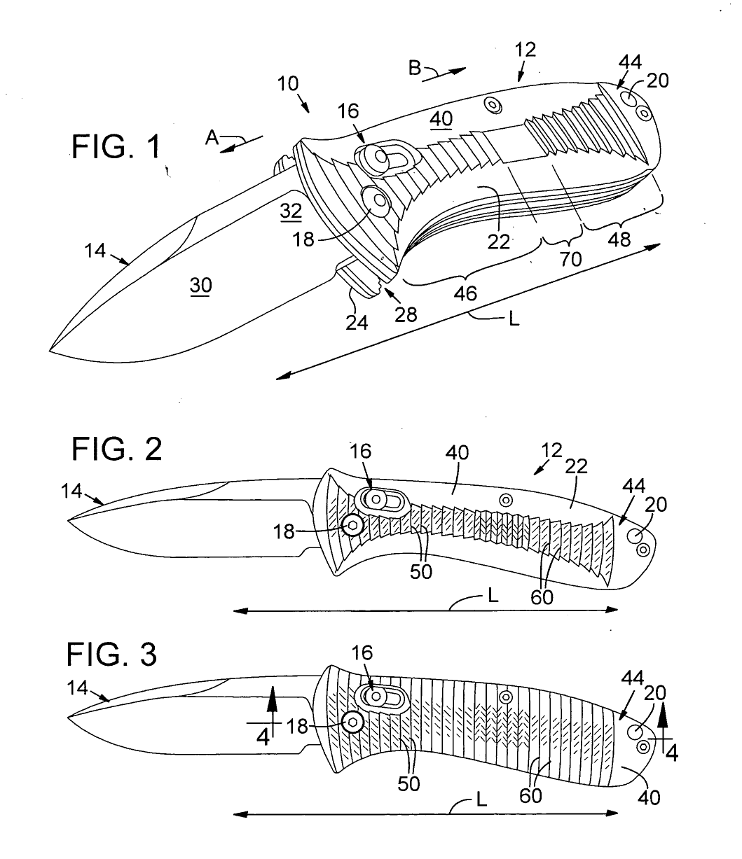

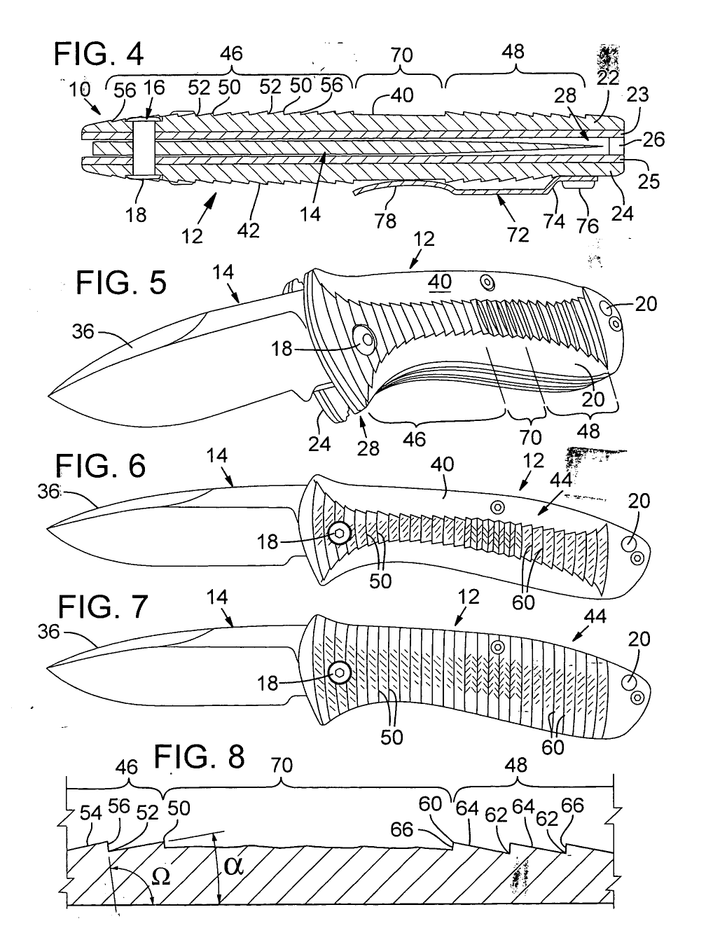

A preferred embodiment of a knife 10 incorporating a handle formed in accordance with the illustrated invention is shown in FIGS. 1 through 8. Although the invention is described with respect to a particular type of tool—a knife—and even then a particular type of knife—a folding knife—it will be appreciated that references to this type of a knife, and indeed this particular type of hand tool, are for illustrative purposes to describe the invention. Those of ordinary skill in the art will appreciate that the invention claimed herein is not limited to knives, regardless of whether they are folding blade knives or fixed blade knives, but instead extends to any hand tool having a handle that is grasped by the user.

With reference to FIG. 1, knife 10 includes a handle 12 and a blade 14. The knife 10 shown in FIG. 1 includes a locking mechanism 16 such as the locking mechanism described in U.S. Pat. No. 6,574,869, which is owned by the assignee of the present application. Blade 14 is pivotally attached to handle 12 with a shaft 18 that has its opposite ends fixed to the handle halves. The knife 10 shown in FIG. 1 also includes a hole 20 formed in the rearward end of the handle 12 for attaching a lanyard and the like, but hole 20 is of course optional. The knives shown in the figures are used to illustrate the invention as claimed—the invention is neither limited to any particular handle shape or knife type, or as noted above, to any particular type of hand tool.

Handle 12 of knife 10 comprises several components, including a pair of oppositely located side wall sections, generally indicated at 22, 24, that are parallel with each other and spaced apart from one another by a spine member 26 (a portion of which is shown in FIG. 4) which is located between the side wall sections along their upper long edges and which curves around the rearward end of the handle (FIG. 4). Side wall sections 22 and 24 may be fabricated in a single piece from any suitable material, including metals such as aluminum alloys and steels, reinforced hard synthetic plastics material such as MICARTA™, and other suitable materials such as other plastics, wood, etc. The side wall sections may be fabricated in multiple pieces.

When handle 12 is assembled, the spine section 26 is disposed between the side walls sections 22 and 24 and extends along the upper edge margins of the side walls. Typically, liner members 23 and 25 (see FIG. 4), which are usually steel, are disposed inwardly alongside side wall sections 22 and 24, respectively, although in some instances liners are not used. When handle 12 is assembled as shown in FIG. 4, the spine section 26 is disposed between the liner members 23 and 25 and extends along the upper edge margins of the liners and side walls 22 and 24. Suitable fasteners such as screws are used to hold together the side wall sections 22 and 24, the liners 23 and 25, and the spine 26.

In the case of a folding knife such as knife 10 illustrated herein, a blade receiving groove 28 is defined between the side wall sections 22 and 24. The blade receiving groove 28 receives the blade 14 when the blade is rotated from its open position (shown in FIG. 1) to its closed position, as shown in FIG. 4.

The blade used with knife 10 may be of any known type and as noted, the particular knife and blade illustrated are for explanation purposes only. The blade 14 shown in the drawings comprises an elongate working portion 30, which generally comprises the forward end of the blade that is exposed when the blade is in the open position, and a tang portion 32, which generally comprises the rearward portion of the blade that pivotally attaches the blade to the handle 12. Working portion 30 typically includes a sharp edge 34 and a blunt edge 36. Blade 14 is attached to handle 12 such that the blade's working portion 30 extends away from the handle 12 when the blade 14 is in its open position (FIG. 1), and tang portion 32 is located within the blade receiving groove 28 when the blade is in either the open or the closed position. That is, the tang portion 32 is always located between the side walls 22, 24 of handle 12. The blade 14 is generally flat and for purposes herein defines a blade or handle plane.

More specifically, the working portion 30 of blade 14 is constructed in a well-known manner and is pivotally attached to the handle 12 by the tang portion 32 so that the sharp edge 34 is received within the handle 12 when the blade is in the closed position shown in FIG. 4.

Knife 10 is generally elongate. The longitudinal axis that extends along knife 10 and handle 12 is referred to herein, and is shown in FIG. 1 as longitudinal axis L, or simply axis L.

Having described knife 10 in a general manner, attention will now be turned to the slip-resistant handle design. With reference first to FIG. 1, the outer surface 40 of side wall section 22 defines the portion of the handle that the user typically grasps, and depending on how the user holds the knife, that portion of the handle that rests in the palm of the user's hand with the thumb extending forwardly. The outer surface 42 of side wall section 24 defines the opposite outer-facing surface of the handle 12, and also provides the user with a surface to grasp, and for most users, defines a rest for the user's fingers. A textured gripping portion, referenced generally with number 44, is formed into the outer surface 40 of sidewall section 22. Likewise, a textured gripping portion 44 is formed into the outer surface 42 of sidewall section 24. As illustrated in FIGS. 1, 2, 5 and 6, the gripping portions 44 may be formed across only a portion of the outer surfaces of the handle, or may be formed entirely across the outer surfaces, as shown in FIGS. 3 and 7. As detailed below, gripping portions 44 comprise a rearward facing ridge portion 46, and forward facing ridge portion 48. As detailed below, a neutral portion 70 that is generally smooth lies between ridge portions 46 and 48.

Gripping portions 44 define two separate ridged areas, each of which define a series of oppositely facing ridges, and which in combination provide significant gripping strength when using the knife 10. To assist in the explanation of the gripping portions 44 and how they function, a “pushing” direction is defined by the direction indicated by arrow A in FIG. 1. A “pulling” direction is defined by the direction indicated by arrow B. Both arrows A and B are shown as being parallel to axis L, but it should be understood that when a user either pushes or pulls the knife in the general directions of A or B, the gripping portions 44 affect the user's grip on the knife handle.

The gripping portions 44 are best described as a series of oppositely facing ridge portions that are defined by a series oppositely facing saw-tooth-like ridges. These gripping portions are identified in the figures as rearward facing ridge portion 46 and forward facing ridge portion 48 (the directional terms “forward” and “rearward” are used with reference to knife 10—forward being in the direction toward the pointed end of blade 30, and rearward being in the direction toward the butt end of handle 12). With reference especially to FIGS. 4 and 8, each of the ridge portions 46 and 48 is defined by a plurality of saw-tooth like ridges oriented in opposite directions relative to one another. Specifically, rearward facing ridge portion 46 is defined by a plurality of ridges 50 and corresponding intervening valleys 52 that are formed into outer facing surface 40. The ridges 50 and valleys 52 are defined by sloping sections 54 that angle upwardly relative to the center of the handle and rearwardly, and face sections 56 that extend across the outer surface 40 such that they define a plane that is in the illustrated embodiment generally transverse to the handle plane. In ridge portion 46, the face sections 56 are oriented such that the face sections 56 face toward the rearward end of handle 12. In all instances the height of face sections 56 (measured from the lowermost point of a face section at the lower intersection between a sloping section 54 and a face section 56, and the uppermost point of a face section at the upper intersection of the face section and the sloping section) is the same along the entire length of the handle. Stated another way, the height of the face sections is the same for every face section on the handle.

The sloping sections 54 and face sections 56 define angles α and Ω as referenced in FIG. 8. Angle Ω, which is defined as the angle between the plane defined by blade 14 and the plane of face section 56, is preferably between about 70° (on either side of the vertical) and more preferably about 90°. Thus, when angle Ω is set to 90° (i.e., vertical), face section 56 is transverse to the plane defined by the blade 14 and such that the plane defined by the face sections intersects the plane defined the plane of the blade 14 at a right angle. Angle α defines the relative angle between the plane of blade 14 and sloping sections 54, and is preferably between about 5° and 25°, and more preferably about 10°.

Similarly, the forward facing ridge portion 48 is defined by a plurality of ridges 60 and corresponding intervening valleys 62 that are formed into outer facing surface 40. The ridges 60 and valleys 62 are defined by sloping sections 64 that angle upwardly relative to the center of the handle and in the forward direction, and face sections 66 that extend across the outer surface 42 such that they are generally transverse the handle plane. In ridge portion 48, the face sections 66 are oriented such that the face sections face the forward end of handle 12. In all instances the height of face sections 66 (measured from the lowermost point of a face section at the lower intersection between a sloping section 64 and a face section 66, and the uppermost point of a face section at the upper intersection of the face section and the sloping section) is the same along the entire length of the handle.

As described previously with respect to rearward facing ridge portion 46, the sloping sections 64 and face sections 66 define angles α and Ω as referenced in FIG. 8 with respect to portion 46. Angle Ω is the angle between the plane defined by blade 14 and the plane of face section 66, is preferably between about 70° (on either side of the vertical) and more preferably about 90°. Thus, when angle Ω is set to 90°, face section 66 is transverse to the plane defined by the blade 14 and such that the plane defined by the face section intersects the plane defined the plane of the blade 14 at a right angle. Angle α defines the relative angle between the plane of blade 14 and sloping sections 64, and is preferably between about 5° and 25°, and more preferably about 10°.

Angles α and Ω may be varied to vary the relative gripping resistance. In a preferred embodiment, angles α and Ω are formed such that the plane of face sections 56 and 66 intersect the handle plane at about 90°, but the angle may be varied as described. Furthermore, the angles α and Ω within ridge portions 46 and 48 may be varied, as may the angles α and Ω between rearward facing ridge portion 46 and forward facing ridge portion 48.

The result of the oppositely facing ridge portions 46 and 48 is that each of the outer surfaces 40 and 42 defines a slip-resistant handle having a portion that frictionally resists inadvertent slipping of the user's grip on the handle 12 when pushing the tool in the forward direction (arrow A), and also when pulling the tool in the rearward direction (arrow B). Thus, with continuing reference to FIG. 8, when the user pushes knife 10 forwardly, that is, in the direction indicated by arrow A, the series of saw tooth ridges 50 and valleys 52 provides significant frictional resistance and gripping strength. Stated otherwise, the ridge portion 46 provides substantial frictional resistance between the user's hand and the handle 12 to reduce the chances of the user's hand slipping. When the user pulls knife 10 rearwardly (the direction of arrow B) the ridges 60 and valleys 62 provide the same function in the opposite direction.

As noted, both outer surfaces 40 and 42 are preferably formed to include ridge portions 46 and 48, although in some instances one surface may preferably but optionally be formed without one or more of the ridge portions. Moreover, the handle 10 may be formed in many different shapes that incorporate one or more of the ridge portions and so is not limited to the elongate knife handle such as the one illustrated.

As noted, a neutral portion 70 may be formed in-between ridge portions 46 and 48, on either one or both of the outer surfaces 40 and 42. Neutral portion 70 does not include any of the saw-tooth like ridge portions as described above, and is preferably relatively smooth compared to the ridged portions. Neutral portion 70 is optional. As illustrated in FIGS. 2, 3, 5, 6, 7 and 8, neutral portion 70, when included, may include a slightly undulating surface in which the undulations are non-directional, or may be smooth. On the other hand, the outer surface of the neutral portion 70 may be smooth, as shown in FIG. 1.

With reference now to FIGS. 2, 3, 6 and 7, the ridge portions are preferably formed such that ridges 50 and 60 are slightly arcuate, although in all instances the ridges are substantially transverse to axis L. As illustrated in FIGS. 2 and 6, the ridge portions may be formed such that the ridges 50 and 60 extend only partially across the handle 12. Alternately, and as shown in FIGS. 3 and 7, the ridge portions may be formed such that the ridges 50 and 60 extend completely across the handle.

Referring to FIG. 4, each of the side walls 22 and 24 are preferably formed such that the outer surfaces 40 and 42, respectively, are slightly arcuate in the longitudinal direction to provide more comfort. This is referred to as a “palm swell” since it increases the comfort of the handle as it rests in the user's palm. Incorporating palm swell into the handle is optional and it will be appreciated, as may be seen in the drawings, that since the height of each of each face section is the same, the combined upper edges of the ridge portions lie in substantially the same plane.

Although the ridge portions described above may be formed into side walls 22 and 24 in any suitable manner, the specific method of forming the ridge portions typically depends upon the material used to fabricate the side walls. For example, when the side walls 22 and 24 are made of metal, wood or some other material that may be cut or ground, the ridge portions are preferably cut into the side walls with a grinder or similar tooling. If the side walls are molded, the ridge portions may be formed into the mold itself, although plastic materials may be cut in the same manner as metal and wood.

As illustrated in FIG. 4, a retaining clip 72 may be provided so that a user may clip the knife 10 in a pocket or on a belt. Retaining clip 72 is a conventional clip that is fabricated from a resilient material such as spring steel. The butt end 74 of the clip 72 is attached to the butt end of handle 12 (that is, the end of the handle opposite the end where blade 14 is attached to the handle) with a suitable fastener such as a screw 76. Clip 72 is elongate and, moving in the direction from butt end 74 toward the front of the clip, curves outwardly from the outer surface 42 of wall section 24 to define a space between the clip and the outer surface. The clip then curves back inwardly toward outer surface 42 and makes contact with outer surface at a contacting portion 78 that rests in the neutral portion 70 of wall section 24. Because the clip 72 is resilient, in a resting position it tends to exert pressure against wall section 24, yet may be easily moved away from wall section 24 to allow the clip to be slipped onto a belt, etc. Because the clip makes contact with outer surface 42 in the neutral portion 70, which is smooth relative to the textured surfaces defined by ridge portions 46, 48, and contains no ridges, a user may easily slip the retaining clip onto and off of their belt and the like.

While the present invention has been described in terms of a preferred embodiment, it will be appreciated by one of ordinary skill that the spirit and scope of the invention is not limited to those embodiments, but extend to the various modifications and equivalents as defined in the appended claims.

1. A handle for a hand tool, comprising:
a handle defining a forward end and a rearward end and defining a longitudinal axis extending between the forward and rearward ends, the handle having an outer surface including a two direction ridge pattern formed on the outer surface, the two directional ridge pattern comprising a plurality of first ridges facing the rearward end and a plurality of second ridges facing the forward end, all of the ridges extending in a direction generally transverse to the longitudinal axis.

2. The handle according to claim 1 wherein the first ridges are located toward the forward end of the handle and the second ridges are located toward the rearward end of the handle.

3. The handle according to claim 1 wherein the handle defines a handle plane, and the first ridges further comprise a plurality of ridges formed into the outer surface, each of the ridges defined at the intersection of a first sloping surface and a second face surface, wherein the second face surface defines a plane that is generally transverse to the handle plane.

4. The handle according to claim 3 wherein the second ridges further comprise a plurality of ridges formed into the outer surface, each of the ridges defined at the intersection of a first sloping surface and a second face surface, wherein the second face surface defines a plane that is generally transverse to the handle plane.

5. The handle according to claim 3 including a valley between each ridge, and wherein the first sloping surface extends from the valley to the ridge in the direction from the forward end toward the rearward end.

6. The handle according to claim 4 including a valley between each ridge, and wherein the first sloping surface extends from the valley to the ridge in the direction from the rearward end toward the forward end.

7. The handle according to claim 1 including a neutral zone between the forward-facing ridges and the rearward-facing ridges, the neutral zone comprising a portion of the outer surface having no ridges.

8. The handle according to claim 1 wherein the ridges are arcuate.

9. The handle according to claim 1 wherein the handle comprises first and second opposed side walls, each side wall defining an outer surface including a two direction ridge pattern formed on the outer surface, the two directional ridge pattern on each side wall comprising a plurality of first ridges facing the rearward end and a plurality of second ridges facing the forward end, all of the ridges extending in a direction generally transverse to the longitudinal axis.

10. A slip-resistant grasp for a tool handle having a handle configured for grasping in a user's hand, comprising:
the tool handle having a forward end and a rearward end and a longitudinal axis and an outer surface that is held in the user's hand, the outer surface including a first series of ridges on the forward end of the handle facing the rearward end, and a second series ridges on the rearward end of the handle facing the forward end, all of the ridges extending in a direction generally transverse to the longitudinal axis.

11. The slip-resistant grasp according to claim 10 wherein the handle comprises first and second side walls, each side wall defining an outer surface including a series of ridges on the forward end of the handle facing the rearward end, and a series ridges on the rearward end of the handle facing the forward end.

12. The slip-resistant grasp according to claim 11 including a section between the first series of ridges and the second series of ridges on at least one of the side walls comprising no ridges.

13. The slip-resistant grasp according to claim 12 including a retaining clip having a first end attached to the handle and a second end contacting the handle in the section between the first series of ridges and the second series of ridges on the at least one of the side walls comprising no ridges.

14. The slip-resistant grasp according to claim 13 wherein each ridge is further defined by the intersection of a first sloping surface and a second face surface, wherein the angle between the sloping surface and the face surface is less than 90°.

15. The slip-resistant grasp according to claim 14 wherein the handle defines a handle plane and the face surface defines a plane that is substantially transverse to the handle plane.

16. In a hand tool having an elongate handle having two opposed side walls, a forward end and a rearward end, and an implement attached to the forward end, the improvement comprising:
a slip-resistant grasp formed in at least one of the two opposed side walls, the slip-resistant grasp defined by a first plurality of saw tooth ridges facing the rearward end and a second plurality of saw tooth ridges facing the forward end.

17. The hand tool according to claim 16 wherein the hand tool is a knife having a knife blade that defines a first plane, and wherein each saw tooth ridge comprises a first face section that defines a second plane that is orthogonal to the first plane.

18. The hand tool according to claim 17 including a slip-resistant grasp formed in both of the two opposed side walls.

19. The hand tool according to claim 18 including a neutral zone in at least one of the two opposed side walls between the first plurality of saw tooth ridges and the second plurality of saw tooth ridges, the neutral zone defining a smooth surface relative to the ridges.

20. The hand tool according to claim 19 including a retaining clip having a first end attached to the handle and a second end contacting the handle in the neutral zone.
